(19) United States
(12) Patent Application Publication
(10) Pub. No.: US 2024/0090988 A1
(43) Pub. Date: Mar. 21, 2024

(54) Dental Hose Attachment and Method of Use

(71) Applicant: Benjamin Stockton, Luling, LA (US)

(72) Inventor: Benjamin Stockton, Luling, LA (US)

(21) Appl. No.: 18/467,593

(22) Filed: Sep. 14, 2023

Related U.S. Application Data
(60) Provisional application No. 63/375,765, filed on Sep. 15, 2022.

(51) Int. Cl. A61C 19/00

(52) U.S. Cl. CPC A61C 19/00

(57) ABSTRACT

A dental or healthcare hose attachment device is provided. The device comprises a wrist band, a device band magnetically attached to the wrist band, and dental or healthcare device hose magnetically attached to the device band.

### FIELD OF THE INVENTION

The present invention relates generally to a dental and healthcare hose attachment. More specifically, the present invention is a device and method of use that removes downward force and torque on a clinician's hand and wrist.

### BACKGROUND OF THE INVENTION

Within the dental and healthcare industry long hours and precise procedures can become taxing on the hands and wrists of a dental or healthcare clinician. This makes it desirable to have a device that that improves ergonomics in the dental and healthcare industry where 40-70% of dental clinicians suffer from muscle skeletal disorders and chronic hand and wrist pain, which is often caused by repetitive use of corded equipment, and the downward force and torque resulting from corded equipment on the hand and wrist.

Furthermore, it would also be desirable to have a device that can seamlessly magnetically attach and detach. Still, further, it would be desirable to have a device that can be heat sterilized or wiped down with high level surface disinfectant due to being used in dental settings. Therefore, there currently exists a need in the industry for a device that improves ergonomics and range of motion for dental and healthcare clinicians who use corded equipment. Similarly, it would be desirable to have an associated method that efficiently attaches and detaches providing ease of use, improved ergonomics, and range of motion. Therefore, there currently exists a need in the dental and healthcare industry for a process that helps dental and healthcare clinicians practice comfortably, safely, and reduces the probability of muscle skeletal disorders.

An objective of the present invention is to provide users with a dental and healthcare equipment attachment, to help eliminate the downward force on a dental or healthcare clinician's hand and wrist. The present invention intends to provide users with a device that can attach and detach magnetically to provide convenience.

In order to accomplish that, a preferred embodiment of the present invention comprises a wrist band and a device band. Thus, the present invention is a wrist band and dental or healthcare hose attachment or hose that magnetically attach to remove downward force on the wrist or hand of the clinician utilizing the device.

### SUMMARY OF THE INVENTION

The present invention is a device and method of use to reduce the number of muscle skeletal disorders in dental clinicians. The present invention seeks to provide users with a device and method of use that magnetically attaches dental or healthcare equipment to the wrist of a dental or healthcare clinician.

In order to accomplish this the present invention comprises a wrist band that wraps around the wrist of the dental or healthcare clinician. Further, the specific device band wraps around the dental or healthcare hose equipment to reduce the amount of downward force on the user. Thus, the present invention is a wrist band and dental or healthcare hose or hose band that magnetically attach to remove downward force on the wrist or hand of the clinician utilizing the device.

### BRIEF DESCRIPTION OF THE DRAWINGS

FIG. 1 is a perspective view of the present invention.

FIG. 2 is a perspective view of an alternative embodiment of the present invention.

FIG. 3 is a perspective view of the wrist band.

FIG. 4 is a perspective view of an alternative embodiment of the wrist band.

FIG. 5 is a perspective view of the device band.

FIG. 6 is a perspective view of an alternative embodiment of the device band.

FIG. 7 is a perspective view of an alternative embodiment of the present invention.

FIG. 8 is a perspective view of an alternative embodiment of the device hose.

### DETAIL DESCRIPTIONS OF THE INVENTION

All illustrations of the drawings are for the purpose of describing selected versions of the present invention and are not intended to limit the scope of the present invention.

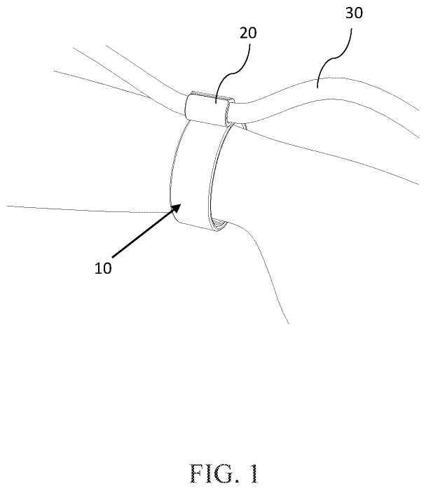

As shown in FIGS. 1-8, the present invention is a device and method of use for a dental or healthcare tool attachment. An objective of the present invention is to provide users with a device and method of use to reduce chronic hand and wrist pain and improve range of motion within dental or healthcare clinicians.

The present invention intends to provide users with a device that magnetically fastens a dental or healthcare hose tool to the wrist of the dental or healthcare clinician.

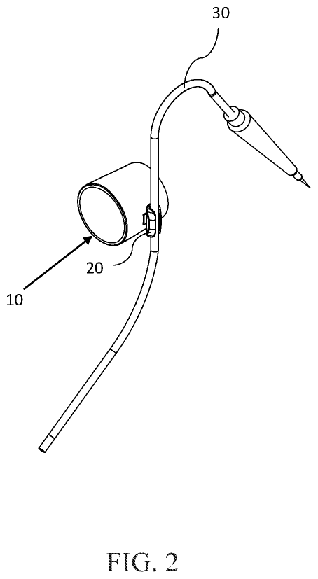

To accomplish this the present invention provides a device that comprises a wrist band 10 and a device band 20 as shown in FIGS. 1-2.

Many of these components allow for the user to easily attach a dental or healthcare tool/hose to their wrist to reduce the downward force created by a corded dental or healthcare tool/hose.

The device band 20 is easily attached and detached to the wrist band 10 via a magnetic connection.

In one embodiment, the device band 20 can attach to a dental or healthcare hose magnetically to remove downward force on the wrist or hand of the clinician utilizing the device.

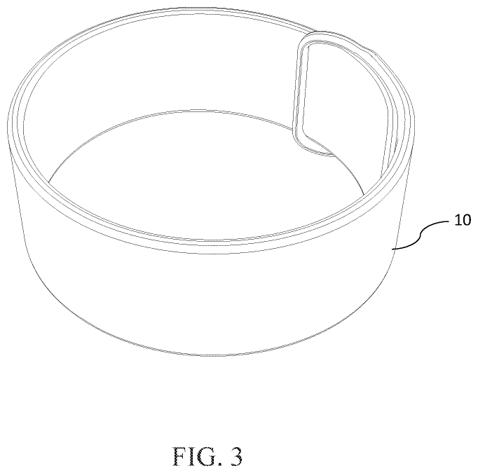

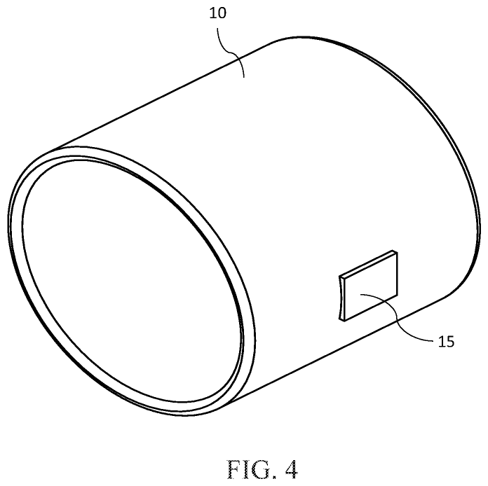

The present invention wraps around the wrist of the dental or healthcare clinician with the wrist band 10. In one embodiment, the wrist band 10 is designed with a silicone material with a thin rectangular shape. In some embodiments, the wrist band 10 can be configured to bend and flex to curl into a circular cylindrical shape as shown in FIG. 3. FIG. 4 shows the wrist band 10 in a cylindrical shape, the wrist band 10 may include a magnet 15 on the surface of the wrist band 10.

The wrist band's 10 silicone material can be designed to withstand high heat and surface disinfectants.

In its preferred embodiment, the wrist band 10 comprises an integrated magnet, a buckle, a radio frequency identification (RFID) sensor, and a wireless radio. The integrated magnet is a magnet of negative polarity that is embedded into the central top side of the wrist band 10, flush underneath the surface of the material.

The buckle is positioned at the terminal end of the wrist band 10 as shown in FIG. 3. The buckle is designed with an oblong ring shape that is designed to secure one end of the wrist band 10 to another end of the wrist band 10 forming a closed circle with the wrist band 10. The RFID sensor is embedded within the wrist band 10. The RFID sensor is designed to measure various data such as procedure time in operatory, ultrasonic scaling time, rotary cutting time, number of computer aided design scans, number of X-rays, and touchless equipment features.

The RFID sensor is electronically connected to the wireless radio that is embedded within the wrist band adjacent to the RFID sensor. The RFID sensor sends collected data to the wireless radio that further sends the data to an external electronic device. The wireless radio can be designed to be a device that can send data wirelessly to an electronic device through means such as Bluetooth. It should be further noted that, the wrist band 10 can be created in many various shapes and sizes and the integrated magnet can be positioned in various ways while still staying within the scope of the present invention.

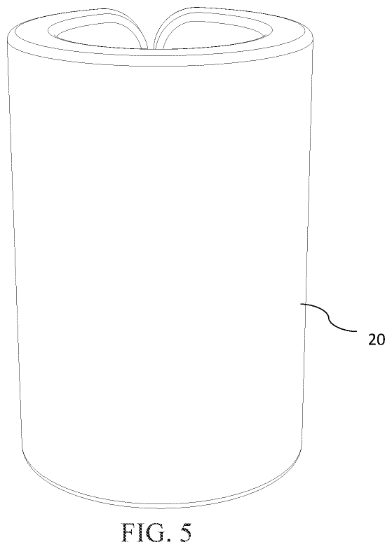

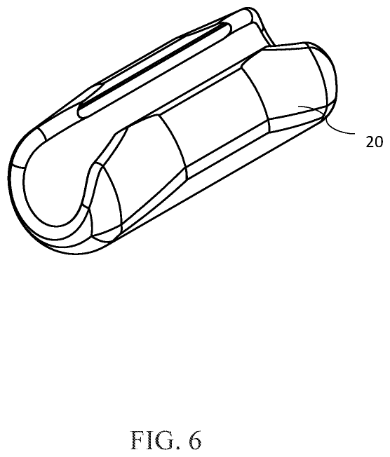

The device band 20 connects with the wrist band 10 via the integrated magnet. The device band 20 has a circular shape and is made with a silicone material as shown in FIG. 5 and FIG. 6.

In some embodiments, the device band 20 can include a piece of metal embedded inside, not a magnet. The device band 20 and the wrist band 10 will be connected by the magnet on the wrist band 10.

The device band 20 is designed to wrap around a dental or healthcare tool/hose.

In its preferred embodiment the device band 20 includes a connecting magnet. The connecting magnet is embedded within the bottom of the device band 20.

This design allows for the device band 20 to be magnetically fastened to the top of the wrist band 10 to reduce the downward force of the attached dental or healthcare tool on the wrist of the dental or healthcare clinician.

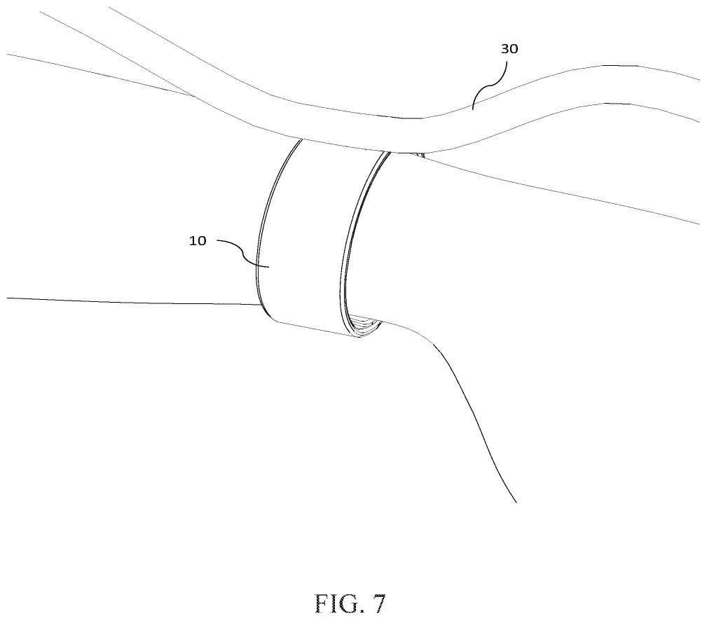

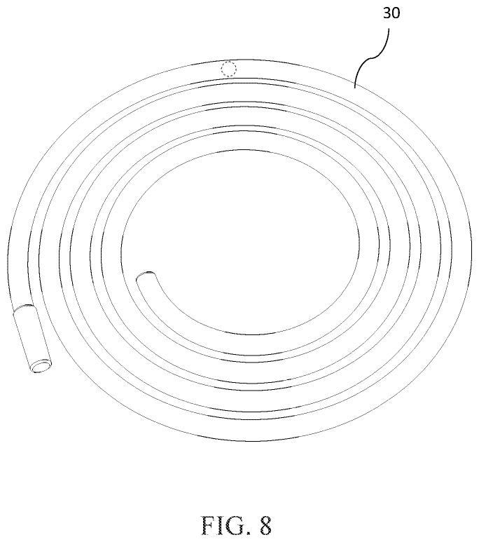

In an alternative embodiment shown in FIG. 7 and FIG. 8, the dental or healthcare device hose 30 is designed with an embedded magnet.

This design allows the dental or healthcare device hose 30 to magnetically connected with the wrist band 10 without the need for the device band 20.

The method of the present invention utilizes the dental or healthcare device hose 30 in the following steps.

In its preferred embodiment the method begins with the dental or healthcare clinician attaching and securing the wrist band 10 to their dominate hand around the wrist area.

The method continues with the dental or healthcare clinician placing the device band 20 along the dental or healthcare device hose 30 approximately 12 to 15 inches from the end of the dental device hose 30.

The method continues with the dental or healthcare clinician picking up the dental or healthcare device 20, where the device band 20 should automatically magnetically connect to the wrist band 10. In the instance where the device band 20 does not automatically connect to the wrist band 10 the dental or healthcare clinician utilizes their non-dominate hand to secure the magnetic connection between the device band 20 and the wrist band 10.

After the dental or healthcare clinician has utilized the dental or healthcare device for their operations or procedures on their patient, the method ends with the dental or healthcare clinician utilizing their non-dominate hand to detach the device band 20 from the wrist band 10. With all the components and steps working in tandem with each other it can be seen that, the present invention is a wrist band 10 and dental or healthcare device hose 30 that magnetically attach to remove downward force on the wrist or hand of the clinician utilizing the device.

Although the invention has been explained in relation to its preferred embodiment, it is to be understood that many other possible modifications and variations can be made without departing from the spirit and scope of the invention.

What is claimed is:

1. A device comprising:
a wrist band,
a device band having a connecting magnet and magnetically attached to the wrist band, and
a dental device hose magnetically attached to the device band.

2. The device as claimed in claim 1, wherein the wrist band includes a silicone material with a rectangular shape.

3. The device as claimed in claim 2, wherein the wrist band is configured to bend into a circular cylindrical shape.

4. The device as claimed in claim 2, wherein the silicone material is designed to withstand high heat and surface disinfectants.

5. The device as claimed in claim 3, wherein the wrist band comprises an integrated magnet.

6. The device as claimed in claim 5, wherein the wrist band includes a buckle.

7. The device as claimed in claim 6, wherein the wrist band includes a wireless radio.

8. The device as claimed in claim 7, wherein the wrist band includes a RFID sensor electronically connected to the wireless radio and configured to send collected data to the wireless radio, the wireless radio is configured to sends the collected data to an external electronic device.

9. A device comprising:
a wrist band configured to bend into a circular cylindrical shape,
a device band having a connecting magnet and magnetically attached to the wrist band, and
a dental device hose magnetically attached to the device band.

10. The device as claimed in claim 9, wherein the wrist band includes a silicone material with a rectangular shape.

11. The device as claimed in claim 10, wherein the silicone material is designed to withstand high heat and surface disinfectants.

12. The device as claimed in claim 10, wherein the wrist band comprises an integrated magnet.

13. The device as claimed in claim 10, wherein the wrist band includes a buckle.

14. The device as claimed in claim 10, wherein the wrist band includes a wireless radio.

15. The device as claimed in claim 14, wherein the wrist band includes a RFID sensor electronically connected to the wireless radio and configured to send collected data to the wireless radio, the wireless radio is configured to sends the collected data to an external electronic device.

16. A device comprising:
a wrist band having a buckle and a wireless radio, the wrist band includes a RFID sensor electronically connected to the wireless radio and configured to send collected data to the wireless radio, the wireless radio is configured to send the collected data to an external electronic device; and
a dental device hose magnetically attached to the wrist band.

17. The device as claimed in claim 16, wherein the wrist band includes a silicone material with a rectangular shape.

18. The device as claimed in claim 17, wherein the wrist band is configured to bend into a circular cylindrical shape.

19. The device as claimed in claim 18, wherein the silicone material is designed to withstand high heat and surface disinfectants.

20. The device as claimed in claim 18, wherein the wrist band comprises an integrated magnet.
